(19) United States
(12) Patent Application Publication
(10) Pub. No.: US 2008/0171265 A1
(43) Pub. Date: Jul. 17, 2008

(54) Positive Electrode For Secondary Battery, Manufacturing Method Thereof, and Secondary Battery

(76) Inventors: Jiro Iriyama, Tokyo (JP); Kentaro Nakahara, Tokyo (JP); Shigeyuki Iwasa, Tokyo (JP); Masahiro Suguro, Tokyo (JP); Masaharu Satoh, Tokyo (JP)

Correspondence Address: SCULLY SCOTT MURPHY & PRESSER, PC, 400 GARDEN CITY PLAZA, SUITE 300, GARDEN CITY, NY, 11530, US

(21) Appl. No.: 11/883,607

(22) PCT Filed: Jan. 19, 2006
(86) PCT No.: PCT/JP06/00695

§ 371 Date: Aug. 2, 2007

(30) Foreign Application Priority Data
Feb. 4, 2005 (JP) 2005-028377

(51) Int. Cl. H01M 4/58; B05D 5/12

(52) U.S. Cl. 429/231.8; 427/77

(57) ABSTRACT

In order to provide a positive electrode for a secondary battery having a low electric resistance and a large mechanical strength, and a secondary battery capable of charge and discharge using a large current and having a large capacity and excellent in storage characteristics, there is used a positive electrode for a secondary battery comprising an active material layer at least comprising a radical compound and a carbon fiber in which a graphite structure has an average value of interlayer distances d₀₀₂ in the range of not less than 0.335 nm and not more than 0.340 nm. Such a carbon fiber having the interlayer distance has a modulus of elongation in the range of not less than 200 GPa and not more than 800 GPa. Particularly the carbon fiber preferably has a volume resistivity in the range of not less than 200μΩ·cm and not more than 2000μΩ·cm. The carbon fiber is preferably a vapor-grown carbon fiber or a graphitized carbon fiber derived from a mesophase pitch as a precursor.

### TECHNICAL FIELD

The present invention relates to a positive electrode for a secondary battery, a manufacturing method thereof, and a secondary battery, more particularly to a positive electrode for a secondary battery containing a radical compound in which the positive electrode has a reduced electric resistance and an enhanced mechanical strength; a manufacturing method thereof; and a secondary battery.

### BACKGROUND ART

As the markets of notebook-size personal computers, cellular phones, electric automobiles and so on rapidly expand; high capacity, high energy density, and high stability are demanded for storage battery devices used for the above applications. In order to meet the demands, secondary batteries using various kinds of materials have been suggested as storage battery devices.

For example, the following Patent Document 1 suggests as a secondary battery having high energy density, high capacity, and being excellent in stability, a lithium secondary battery using a radical compound such as a nitroxyl radical compound, an oxy radical compound, an aryl oxy radical compound, or a polymer compound having an aminotriazine structure for an active material layer of a positive electrode.

In addition, the following Patent Document 2 suggests as a secondary battery having high energy density and usable in a large current, a lithium secondary battery in which an active material layer of a positive electrode contains a nitroxyl compound which takes a nitroxyl cation moiety structure in its oxidized state and a nitroxyl radical moiety structure in its reduced state; and an electron donating and accepting reaction between the oxidized state and the reduced state is used as an electrode reaction of the positive electrode.

In addition, the following Patent Document 3 suggests as a secondary battery having high energy density, high capacity, and high stability, a lithium secondary battery including at least a positive electrode, a negative electrode and an electrolyte as components, including particles containing an organic compound generating a radical compound, during at least either of the processes of an electrochemical oxidization reaction and a reduction reaction as an active material, and that the particles are a complex matter comprising at least two composition regions and constitute an active material layer for a positive electrode.

In addition, the following Patent Document 4 suggests as a secondary battery with an enhanced electrical conductivity of an electrode and an enhanced mechanical strength, a lithium secondary battery using an electrically conductive matrix for an active material layer of a positive electrode in which an active material layer contains disulfide groups and S—S bonds of the disulfide groups are cleaved by electrochemical reduction and reformed by electrochemical oxidation. This lithium secondary battery has carbon nano-tubes dispersed in the electrically conductive matrix.

Patent Document 1: Japanese Patent Laid-Open No. 2002-151084

Patent Document 2: Japanese Patent Laid-Open No. 2002-304996

Patent Document 3: Japanese Patent Laid-Open No. 2002-298850

Patent Document 4: Japanese Patent Laid-Open No. 11-329414

### DISCLOSURE OF THE INVENTION

### Problems to be solved by the Invention

However, the lithium secondary batteries disclosed in the Patent Documents 1 to 3 cause a problem that active material layers have high electrode resistances because the radical compounds contained in the active material layers have low electrical conductivities. In addition, such active material layers have relatively small mechanical strengths, and which can cause cracks in the active material layers. As a result, there is a possibility that electrode resistance of the active material layers will become high. A lithium secondary battery having an active material layer with high electric resistance tends to cause a problem of insufficient battery capacity on charge and discharge using a large current. Consequently, solutions of the problem have been demanded.

In addition, the lithium secondary batteries disclosed in the Patent Documents 1 to 3 have low mechanical strengths, which can cause dropping off of the active material layers from collectors during storage of the lithium secondary batteries in which charge and discharge are not conducted, and which can result in decrease of charge and discharge capacities (referred to as storage characteristics) of the active material layers during storage.

On the other hand, the lithium secondary battery disclosed in the Patent Document 4 has a low efficiency of reforming the cleft S—S bonds in an electrochemical reaction on charge and discharge and thus has less stability on charge and discharge than the lithium secondary batteries disclosed in the Patent Documents 1 to 3 using radical compounds for active material layers. Therefore, the lithium secondary battery disclosed in the Patent Document 4 has a problem of having difficulty in being used as a secondary battery with a large capacity capable of charge and discharge using a large current. Consequently, solutions of the problem have been demanded.

The present invention has been accomplished to solve the above problems. A first object of the present invention is to provide a positive electrode for a secondary battery having a low electric resistance and a high mechanical strength and a manufacturing method of the positive electrode. In addition, a second object of the present invention is to provide a secondary battery capable of charge and discharge using a large current, having a large capacity and excellent in storage characteristics.

### Means for Dissolving the Problems

In order to dissolve the problems, a positive electrode for a secondary battery according to the present invention comprises an active material layer at least comprising a radical compound and a carbon fiber in which a graphite structure has an average value of interlayer distances d₀₀₂ in the range of not less than 0.335 nm and not more than 0.340 nm.

According to this invention, the active material layer comprises a radical compound and a carbon fiber. This is considered to provide a remarkably low interface resistance between the radical compound and the carbon fiber, and thus the active material layer containing these can have a high electrical conductivity. As a result, a positive electrode for a secondary battery having a low electric resistance can be formed. In addition, the carbon fiber contained in the active material layer comprises a graphite structure having an average value of interlayer distances d₀₀₂ in the range of not less than 0.335 nm and not more than 0.340 nm. A carbon fiber satisfying the range has a high mechanical strength, and thus an active material layer comprising such a carbon fiber can have a high mechanical strength. As a result, it is possible to form a positive electrode for a secondary battery comprising an active material layer with a high electrical conductivity and without causing cracks or dropping off. In addition, in the positive electrode for a secondary battery according to the present invention, an active material layer comprises a radical compound, whereby a secondary battery using the positive electrode for a secondary battery can have a large capacity.

In the positive electrode for a secondary battery according to the present invention, the carbon fiber preferably has a modulus of elongation in the range of not less than 200 GPa and not more than 800 GPa.

The carbon fiber, in which an average value of interlayer distances d₀₀₂ of a graphite structure is in the range of not less than 0.335 nm and not more than 0.340 nm as described above, generally has a large modulus of elongation in the range of not less than 200 GPa and not more than 800 GPa. This invention makes it possible for an active material layer comprising such a carbon fiber and a positive electrode for a secondary battery comprising the active material layer to have high mechanical strengths.

In the positive electrode for a secondary battery according to the present invention, a volume resistivity of the carbon fiber is preferably in the range of not less than 200 μΩ·cm and not more than 2000 μΩ·cm.

According to this invention, since a volume resistivity of the carbon fiber comprised in an active material layer is in the range of not less than 200 μΩ·cm and not more than 2000 μΩ·cm, an electrical conductivity of the active material layer comprising such a carbon fiber becomes high. As a result, a positive electrode for a secondary battery comprising such an active material layer can decrease an electrode resistance.

In the positive electrode for a secondary battery according to the present invention, the carbon fiber is preferably a vapor-grown carbon fiber.

According to this invention, since the carbon fiber is a vapor-grown carbon fiber, which has an excellent dispersibility, it makes possible to increase dispersion of the carbon fiber in the radical compound on producing the active material layer. As a result, it is possible to obtain easily an active material layer having uniform characteristics in every part and a positive electrode for a secondary battery comprising the active material layer.

In addition, in the positive electrode for a secondary battery according to the present invention, the carbon fiber is preferably a graphitized carbon fiber derived from a mesophase pitch as a precursor. The mesophase pitch has a uniform optical anisotropy by causing a polycondensation reaction of a polycyclic aromatic compound contained in coal tar or petroleum pitch with heating or the like. A carbon fiber derived from such a mesophase pitch as a precursor can be baked at temperatures of from 2600° C. to 3000° C. to provide a carbon fiber with an extremely high graphitization degree. Such a carbon fiber with an extremely high graphitization degree is sperior in electrical conductivity and mechanical strength. Therefore, use of the carbon fiber for a positive electrode can easily provide a positive electrode for a secondary battery having a low electric resistance and an excellent mechanical strength.

In the positive electrode for a secondary battery according to the present invention, the content of the carbon fiber in the active material layer is preferably in the range of not less than 10 weight % and not more than 50 weight %.

According to this invention, the active material layer contains the carbon fiber not less than 10 weight %, thereby allowing to increase the mechanical strength of the active material layer. As a result, a positive electrode for a secondary battery according to the present invention can have an increased mechanical strength. On the other hand, the active material layer preferably contains the carbon fiber not more than 50 weight %, thereby allowing to relatively increase the ratio of the radical compound content in the active material layer. As a result, a secondary battery using the positive electrode for a secondary battery according to the present invention has a large capacity.

In the positive electrode for a secondary battery according to the present invention, the radical compound preferably comprises at least one of a nitroxyl radical compound, an oxy radical compound, and a nitrogen radical compound. In particular, the nitroxyl radical compound is preferably poly(4-methacryloyloxy-2,2,6,6-tetramethylpiperidin-1-oxyl), poly(4-acryloyloxy-2,2,6,6-tetramethylpiperidin-1-oxyl), or poly(4-vinyloxy-2,2,6,6-tetramethylpiperidin-1-oxyl).

In order to solve the above problems, a method for manufacturing a positive electrode for a secondary battery according to the present invention is a method for manufacturing a positive electrode for a secondary battery comprising an active material layer comprising at least a radical compound and a carbon fiber, characterized by comprising a step of dispersing the carbon fiber in which a graphite structure has an average value of interlayer distances d₀₀₂ in the range of not less than 0.335 nm and not more than 0.340 nm in a solvent containing the radical compound.

According to this invention, it is possible to manufacture a positive electrode for a secondary battery having a low electric resistance and a high mechanical strength.

In the method for manufacturing a positive electrode for a secondary battery according to the present invention, the carbon fiber is preferably dispersed so that the active material layer contains the carbon fiber in the range of not less than 10 weight % and not more than 50 weight %.

According to this invention, the carbon fiber is dispersed so that the active material layer contains the carbon fiber in the above range, thereby allowing to form an active material layer having uniform electric resistance and mechanical characteristics in every part. As a result, it is possible to manufacture a positive electrode for a secondary battery having a low electric resistance and a high mechanical strength.

In order to solve the above problems, a secondary battery according to the present invention is a secondary battery comprising at least a positive electrode, a negative electrode, and an electrolyte, characterized in that the positive electrode is the positive electrode for a secondary battery according to the present invention.

According to this invention, the secondary battery comprises the positive electrode for a secondary battery comprising an active material layer comprising a radical compound and having a low electrode resistance and a high mechanical strength. This enables charge and discharge using a large current, thereby allowing to provide the secondary battery having a large capacity and excellent in storage characteristics.

### EFFECTS OF THE INVENTION

As mentioned above, in the positive electrode for a secondary battery according to the present invention, an active material layer has an enhanced electrical conductivity, and does not cause cracks or dropping off. Consequently, it is possible to form a positive electrode for a secondary battery having a low electric resistance and a high mechanical strength. In addition, in the positive electrode for a secondary battery according to the present invention, its active material layer comprises a radical compound, whereby a secondary battery using the positive electrode for a secondary battery can have a large capacity.

In addition, according to the method for manufacturing a positive electrode for a secondary battery according to the present invention, it is possible to form an active material layer having uniform electric resistance and mechanical characteristics in every part. As a result, it is possible to manufacture a positive electrode for a secondary battery having a low electric resistance and a high mechanical strength.

In addition, the secondary battery according to the present invention comprises a positive electrode for a secondary battery having a high mechanical strength, thereby allowing to restrain an increase of electrode resistance due to cracks in an active material layer or a deterioration of storage characteristics due to dropping off of the active material layer. Furthermore, the secondary battery according to the present invention comprises the positive electrode for a secondary battery comprising an active material layer comprising a radical compound and having a low electrode resistance and a high mechanical strength. This enables charge and discharge using a large current, thereby allowing to provide the secondary battery having a large capacity and excellent in storage characteristics.

### BRIEF DESCRIPTION OF THE DRAWINGS

FIG. 1 is a schematic section view showing an embodiment of a secondary battery according to the present invention.

### DESCRIPTION OF SYMBOLS

1: an active material layer of a positive electrode;
2: an active material layer of a negative electrode;
3: a positive electrode collector;
4: a negative electrode collector;
5: an electrolyte;
6: a positive exterior can;
7: a negative exterior can;
8: an insulating gasket portion;
10: a lithium secondary battery;
11: a positive electrode;
12: a negative electrode; and
13: a separator.

### BEST MODE FOR CARRYING OUT THE INVENTION

Hereinafter, a positive electrode for a secondary battery, a manufacturing method of the positive electrode, and a secondary battery according to the present invention are explained.

### (Positive Electrode for Secondary Battery)

A positive electrode for a secondary battery according to the present invention comprises an active material layer comprising at least a radical compound and a carbon fiber in which a graphite structure has an average value of interlayer distances d₀₀₂ in the range of not less than 0.335 nm and not more than 0.340 nm. The active material layer is generally formed on a collector to constitute a part of a positive electrode for a secondary battery. It should be noted that the collector is not particularly restricted, and collectors formed with general materials and having general shapes are preferably used. Examples of materials for the collector may include various types of materials such as aluminum, nickel, aluminum alloy, nickel alloy, or carbon. Examples of the shapes for the collector may include a foil, a plate, or a mesh.

### (Radical Compound)

A radical compound is a compound which constitutes an active material layer as an active material. The radical compound comprises a free radical having an unpaired electron (namely, a radical). The radical compound that constitutes the present invention has a high radical density and the state of spin concentration being 10²¹ spin/g or more is kept for 1 second or more in an equilibrium state. In addition, as to a charged state of the radical compound that constitutes the present invention, electrically neutral is preferable in view of easiness of charge and discharge reactions.

It is noted that a radical has spin angular momentum, and thus radical density (density of unpaired electrons) becomes equal to spin concentration. The spin concentration refers to a value obtained from the intensity of an absorption area of electron spin resonance spectrum (hereafter, referred to as ESR spectrum), for example, by the following method. First, a sample to be used for an ESR spectrum measurement is ground and pulverized in a mortar or the like. By this treatment, the sample can be pulverized to particles having sizes that a skin effect (a phenomenon that a microwave does not achieve the inside of a sample) is negligible. A certain amount of the pulverized sample is charged into a capillary made of silica glass having an inside diameter of 2 mm or less, desirably 1 to 0.5 mm. The capillary is degassed to 1.33 to 0.67 kPa (10 to 5 mmHg) or less and sealed. Then ESR spectrum can be measured. The ESR spectrum can be measured, for example, by using JEOL-JES-FR30 type ESR spectrometer or the like. The spin concentration can be obtained by integrating the obtained ESR signal twice and comparing the value to a calibration curve. It should be noted that measuring devices and measuring conditions are not restricted in the present invention as long as the spin concentration is accurately measured.

Examples of the radical compound can include a polymeric nitroxyl radical compound, a polymeric oxy radical compound, and a polymeric hydrazyl radical compound. In the present invention, at least one or more of these radical compounds may be used as an active material.

Among the radical compounds, the polymeric nitroxyl radical compound, namely a polymer having nitroxyl, is most preferably used. Nitroxyl has a remarkably high stability due to delocalization of its radical, and thus particularly preferable as an active material. Examples of the polymeric nitroxyl radical compound can include A-1 to A-8 represented by the following chemical structural formulae. In these polymeric nitroxyl radical compounds, each radical is further stabilized due to steric hindrance by adjacent bulky substituents or a resonance structure. In addition, as a main-chain of the polymer, polymers such as poly(meth)acrylic acid, polyalkyl(meth)acrylates, polyvinyl ethers, or poly(meth)acrylamide are particularly preferable because these polymers are highly resistant to oxidation and reduction, and electrochemically stable. In the formulae, R₁ to R₅ independently represent alkyl groups, and the alkyl groups are methyl groups, ethyl groups or the like. In particular, methyl groups are preferably used because of electrochemical stability and a large capacity.

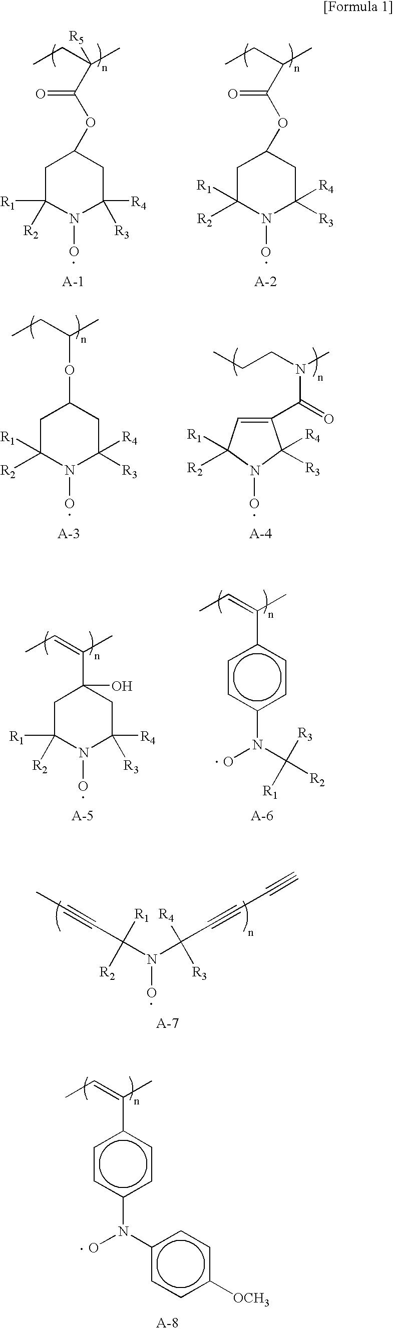

The polymeric oxy radical compound is a polymer having an oxy radical.

Examples of the polymeric oxy radical compound can include A-9 to A-11 represented by the following chemical structural formulae. In addition, the polymeric hydrazyl radical compound is a polymer having a hydrazyl radical. Examples of the polymeric hydrazyl radical compound can include A-12 and A-13 represented by the following chemical structural formulae. In the formulae, R₁ to R₆ independently represent alkyl groups, and the alkyl groups are methyl groups, ethyl groups or the like. In particular, methyl groups are preferably used because of electrochemical stability and a large capacity.

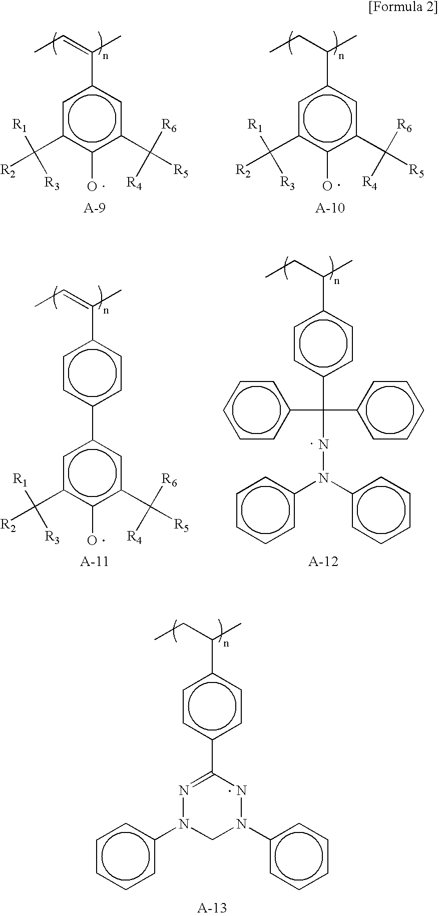

### (Carbon Fiber)

In a carbon fiber according to the present invention, a graphite structure has an average value of interlayer distances d₀₀₂ in the range of not less than 0.335 nm and not more than 0.340 nm. In the present invention, such a carbon fiber is contained in an active material layer. This is considered to provide a remarkably low interface resistance between the above-mentioned radical compound and the carbon fiber, and thus the active material layer containing these can have a high electrical conductivity.

In the present invention, the average value of interlayer distances d₀₀₂ of a graphite structure of a carbon fiber can be measured, for example, by X-ray diffraction. Specifically, the average value can be presented by analytical results of an X-ray diffraction peak that appears as the average value of respective interlayer distances d₀₀₂ in a graphite structure of a carbon fiber. A carbon fiber that has interlayer distances in the range has a high mechanical strength (for example, a modulus of elongation), and thus an active material layer can have a high mechanical strength. As a result, an active material layer without causing cracks or dropping off is obtained, and it is possible to form a secondary battery having an active material layer with a high electrical conductivity.

When a graphite structure of a carbon fiber has an average value of interlayer distances d₀₀₂ more than 0.340 nm, the carbon fiber has an insufficient mechanical strength (for example, a modulus of elongation), and thus an active material layer comprising the carbon fiber can have an insufficient mechanical strength. On the other hand, an ideal interlayer distance d₀₀₂ of a graphite structure is 0.335 nm, and there exists no carbon fiber having an interlayer distance less than 0.335 nm.

The carbon fiber preferably has a modulus of elongation in the range of not less than 200 GPa and not more than 800 GPa. The carbon fiber in which a graphite structure has an average value of interlayer distances d₀₀₂ in the range of not less than 0.335 nm and not more than 0.340 nm generally has a large modulus of elongation in the range of not less than 200 GPa and not more than 800 GPa. An active material layer comprising such a carbon fiber has a high mechanical strength, and it is possible to increase the mechanical strength of a positive electrode for a secondary battery. When the carbon fiber has a modulus of elongation less than 200 GPa, the carbon fiber has an insufficient mechanical strength, and thus an active material layer comprising the carbon fiber can have an insufficient mechanical strength. On the other hand, the upper limit of the modulus of elongation of a carbon fiber is defined as 800 GPa in view of the cost of manufacturing the carbon fiber. It should be noted that a definition and a measurement method of the modulus of elongation of a carbon fiber are compliant with JIS R7601-1986 Test Method for Carbon Fiber).

An active material layer comprising the above-mentioned carbon fiber has a feature of which a mechanical strength increases. In the present invention, the carbon fiber preferably has a volume resistivity in the range of not less than 200 μΩ·cm and not more than 2000 μΩ·cm. An electrical conductivity of the active material layer becomes high by comprising such a carbon fiber having a volume resistivity in the range. As a result, an electrode resistance of the positive electrode for a secondary battery comprising such an active material layer can be reduced. The lower limit of the volume resistivity of a carbon fiber is defined as 200 μΩ·cm in view of the cost of manufacturing the carbon fiber. On the other hand, when a carbon fiber has a volume resistivity more than 2000 μΩ·cm, there is a possibility that a positive electrode does not have a sufficiently decreased electrode resistance. It should be noted that a definition and a measurement method of the volume resistivity of a carbon fiber are also compliant with JIS R7601-1986 (Test Method for Carbon Fiber) as with the modulus of elongation.

The types of carbon fibers are classified according to their manufacturing methods. Carbon fibers applicable to the present invention are not particularly restricted, and various types of carbon fibers that satisfy the characteristics mentioned above may be used. Examples of such carbon fibers to be used may include: PAN carbon fibers obtained by carbonizing a polyacrylonitrile (PAN) precursor; pitch carbon fibers obtained by using a pitch obtained in refining petroleum or coal as a precursor and carbonizing and graphitizing the precursor; vapor-grown carbon fibers (VGCF) obtained by using hydrocarbon vapors and growing fibers on substrates in a reactor; carbon nano-tubes (CNT) obtained by an arc discharge method using arc discharge between graphite electrodes; and the like. These carbon fibers may be used alone or in combination of two or more of them.

When such a carbon fiber is used to form an active material layer, a step of dispersing the carbon fiber into a radical compound in a solvent is conducted. The vapor-grown carbon fibers (VGCF) has a particularly excellent dispersibility in the step and thus most preferably used.

In addition, a mesophase pitch carbon fiber is particularly preferable because of excellent electrical conductivity and mechanical strength. The mesophase pitch carbon fiber is obtained by using a mesophase pitch having an optical anisotropy as a precursor among pitches obtained in refining petroleum or coal and carbonizing and graphitizing the precursor. Furthermore, use of a mesophase pitch to which boron is added in the range of 10 to 50 ppm as a precursor is preferable because the pitch is more easily graphitized.

The size of a carbon fiber to be used in the present invention is not particularly restricted. In general, a carbon fiber preferably used in the present invention is a fibrous matter having an average length of not less than 10 μm and not more than 200 μm, and an average diameter of not less than 0.4 μm and not more than 4 μm because of high dispersibility. It should be noted that the average length and the average diameter are average values of lengths and diameters obtained by measuring 1000 or more carbon fibers in observing the carbon fibers with an electron microscope or the like.

### (Active Material Layer)

An active material layer is formed on a collector to constitute a positive electrode for a secondary battery according to the present invention. The active material layer at least comprises the radical compound and the carbon fiber.

The active material layer preferably comprises the carbon fiber in the range of not less than 10 weight % and not more than 50 weight %. When the active material layer comprises the carbon fiber in the range, it is possible to increase the mechanical strength of the active material layer and decrease the electric resistance of the active material layer. If the content of the carbon fiber in the active material layer is less than 10 weight %, the active material layer may cause cracks or dropping off, and may become insufficient in mechanical strength. On the other hand, if the content of the carbon fiber in the active material layer is more than 50 weight %, the ratio of the radical compound that functions as an active material is decreased relatively, and thus a secondary battery comprising a positive electrode comprising the active material layer has a reduced capacity.

In an active material layer constituting a positive electrode for a secondary battery according to the present invention, there is a phenomenon that the active material layer containing a carbon fiber has a remarkably high electrical conductivity. This is considered that a radical compound and carbon constituting a carbon fiber have almost the same energy barriers on charge transfer between the radical compound and the carbon, and thus an interface resistance between the radical compound and the carbon fiber is decreased.

Such a phenomenon is an outstanding effect obtained by combining a radical compound and a carbon fiber. The present inventor has confirmed that use of other conductive materials such as gold, silver or copper instead of a carbon fiber does not increase the electrical conductivity of an active material layer.

It should be noted that, in the active material layer disclosed in the Patent Document 4 (the active material layer in which carbon nano-tubes are dispersed in an electrically conductive matrix having disulfide groups), dispersing of silver, gold, copper or the like which has an electrical conductivity similar to carbon nano-tubes instead of carbon nano-tubes to form the active material layer results in the active material layer having a high electrical conductivity as much as an active material layer using carbon nano-tubes. In this point, the active material layer disclosed in the Patent Document 4 is different from the active material layer used in the present invention.

### (Method for Manufacturing Positive Electrode for Secondary Battery)

Next, a method for manufacturing a positive electrode for a secondary battery is explained. A method for manufacturing a positive electrode for a secondary battery according to the present invention is a method for manufacturing a positive electrode for a secondary battery comprising an active material layer at least comprising a radical compound and a carbon fiber, and specifically, characterized by comprising a step of dispersing the carbon fiber in which its graphite structure has an average value of interlayer distances d₀₀₂ in the range of not less than 0.335 nm and not more than 0.340 nm in a solvent containing the radical compound.

First, a solution in which the radical compound is dissolved in a solvent is prepared. The solution is mixed with the carbon fiber and a binder. An ultrasonic wave is irradiated to the mixed solution to disperse the carbon fiber in the mixed solution, whereby a slurry is obtained. Then the slurry is coated on a collector at a given thickness, and subsequently the solvent is evaporated to manufacture a positive electrode for a secondary battery comprising an active material layer.

Examples of the solvent may include: n-methylpyrrolidone (NMP), tetrahydrofuran (THF), toluene, and the like. These solvents may be used alone or in admixture of two or more solvents.

Examples of the binder may include: polyvinylidene fluoride, vinylidene fluoride-hexafluoropropylene copolymer, vinylidene fluoride-tetrafluoroethylene copolymer, and the like. These binders may also be used alone or in admixture of two or more binders. The content of the binder contained in the active material layer is preferably in the range of not less than 1 weight % and not more than 10 weight %. When the content of the binder in the active material layer is less than 1 weight %, the formed active material layer does not have enough adhesion to a collector and may come off from the collector. On the other hand, when the content of the binder in the active material layer is more than 10 weight %, the content of the radical compound or the carbon fiber in the active material layer is decreased relatively, and the capacity of thus a secondary battery comprising a positive electrode according to the present invention may be reduced or the mechanical strength of active material layer may become insufficient.

As an another method for manufacturing a positive electrode for a secondary battery, it is possible to manufacture a positive electrode for a secondary battery comprising an active material layer by dissolving the radical compound in a solvent, impregnating this solution into a sheet formed with the carbon fiber, and then evaporating the solvent. It should be noted that, in this case, the sheet formed with entangled carbon fibers functions as a collector, and thus the positive electrode does not include the binder as described above.

### (Secondary Battery)

Next, a secondary battery according to the present invention is explained. A secondary battery according to the present invention comprises a positive electrode, a negative electrode, and an electrolyte, and as the positive electrode, the above-mentioned positive electrode for a secondary battery is used. This secondary battery uses the positive electrode for a secondary battery according to the present invention, thereby allowing to reduce increase of electrode resistance due to cracks in an active material layer, and deterioration of storage characteristics due to dropping off of the active material layer. In addition, the active material layer of the positive electrode comprises a radical compound, which functions as an active material, and has a low electrode resistance, whereby it becomes possible to increase the charge and discharge capacity using a large current. Therefore, the secondary battery is capable of charge and discharge using a large current, has a large capacity and excellent in storage characteristics.

In the present invention, a stack configuration of a positive electrode and a negative electrode is not particularly restricted, and an arbitrary stack configuration may be employed. Examples of the stack configuration may include: a multilayer stack, a configuration combining electrodes stacked on each surface of a collector, and a configuration winding these.

The shape of a secondary battery according to the present invention is also not particularly restricted, and shapes conventionally known in the art may be used. Examples of the shapes may include: a coin, a cylinder, a rectangle, a sheet, or the like.

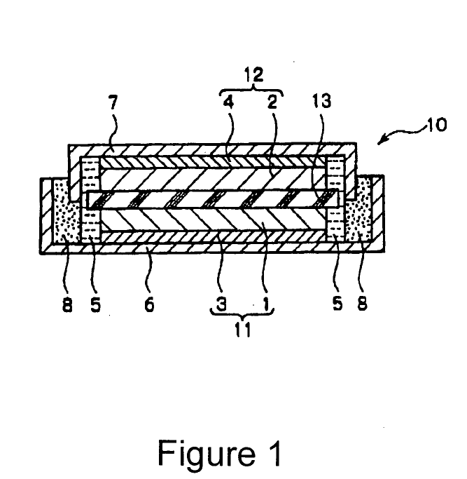

FIG. 1 is a schematic section view of a coin type secondary battery, which is an embodiment of a secondary battery according to the present invention. Coin type secondary battery 10 shown in FIG. 1 comprises positive electrode 11 and negative electrode 12. Positive electrode 11 comprises active material layer 1 and collector 3. Negative electrode 12 comprises active material layer 2 and collector 4. Between positive electrode 11 and negative electrode 12, porous separator 13 is interposed for preventing electric connections between the electrodes. Positive electrode 11, negative electrode 12 and separator 13 are immersed in electrolyte 5. These are sealed in positive exterior can 6 and negative exterior can 7 with insulating gasket portion 8 to form the battery.

As for the negative electrode, as with the positive electrode, an active material layer for a negative electrode is formed on a collector. The active material layer comprises an active material for a negative electrode. The active material for a negative electrode is not particularly restricted, and active materials conventionally known in the art may be used as long as the materials have a lower oxidation-reduction potential than the positive electrode. For example, any one of the following carbon materials may be used: natural graphite, petroleum coke, coal coke, pitch coke, carbon black, activated carbon, baked resin carbon, baked organic polymer, pyrolytic vapor-grown carbon fiber, mesocarbon microbeads, mesophase pitch carbon fiber, polyacrylonitrile carbon fiber, fullerene, carbon nano-tube, or the like. In addition, Li materials may also be used such as metallic lithium, lithium alloy, lithium nitride, Li₃₋ₓMₓN (x is 0≦x≦1, and M represents at least one element selected from Co, Ni, and Cu). These materials may be used alone or in admixture of two or more materials.

As the collector, collectors made of any one material among copper, silver, copper alloy, silver alloy and carbon may be used. Examples of the shape of the collector can be any one of a foil, a plate, or a mesh. Examples of a method for forming an active material layer containing an active material for a negative electrode on a collector can include a method of applying an admixture of the active material for a negative electrode and a binder to the collector.

The binder is not particularly restricted, and binders conventionally known in the art may be used. Examples of the binders may include polyvinylidene fluoride, vinylidene fluoride-hexafluoropropylene copolymer, and vinylidene fluoride-tetrafluoroethylene copolymer. These materials may be used alone or in admixture of two or more materials. In addition, particularly when metallic lithium or lithium alloy is used as an active material for a negative electrode, use of the same material for a collector makes it possible to form the whole negative electrode with an identical material.

As the electrolyte, an electrolyte in which an electrolytic salt is dissolved in an electrolytic solvent is used. Materials used for these are not particularly restricted, and materials conventionally known in the art may be used. The electrolyte desirably has an ionic conductivity of 10⁻⁵ to 10⁻¹ S/cm at 20° C.

As the electrolytic salt, lithium salts selected from LiPF₆, LiAsF₆, LiAlCl₄, LiClO₄, LiBF₄, LiSbF₆, LiCF₃SO₃, LiCF₃CO₂, Li(CF₃SO₂)₂, LiN(CF₃SO₂)₂, and the like may be used. As for other electrolytic salts, salts selected from the following may be used: quaternary ammonium salts such as tetraammonium tetrafluoroborate or tetraethylammonium tetrafluoroborate; quaternary phosphonium salts such as tetraethylphosphonium tetrafluoroborate; imidazolium salts such as ethylmethylimidazolium tetrafluoroborate, and the like. These materials may be used alone or in admixture of two or more materials.

The electrolytic solvent is capable of dissolving the electrolytic salt, and selected arbitrarily depending on an electrolytic salt to be used. As the electrolytic solvent, admixture of two or more of cyclic carbonates such as propylene carbonate (PC), ethylene carbonate (EC), butylene carbonate (BC), or vinylene carbonate (VC); and chain carbonates such as dimethyl carbonate (DMC), diethyl carbonate (DEC), ethylmethyl carbonate (EMC), or dipropyl carbonate (DPC) may be used.

The separator is not particularly restricted, and separators conventionally known in the art may be used. Examples of materials for a separator may include polyolefins such as polypropylene or polyethylene; fluorocarbon resins, and the like. As for the shape of the separator, for example, a porous thin film is preferably used.

### EXAMPLES

Hereinafter, the present invention will be explained further in detail referring to Examples and Comparative Examples.

### Example 1

First, a positive electrode was prepared. As a radical compound, poly(4-methacryloyloxy-2,2,6,6-tetramethylpiperidin-1-oxyl) (PTME) was synthesized, which is represented by the formula A-1 (each of R₁ to R₅ represents a methyl group), and a polymer having a cyclic nitroxyl structure.

Synthetic Example of Polymer Having Cyclic Nitroxyl Structure; 20 g (0.089 mol) of 4-methacryloyloxy-2,2,6,6-tetramethylpiperidin-1-oxyl monomer was charged in a 100 ml egg-plant type flask equipped with a reflux condenser, and dissolved in 80 ml of dried tetrahydrofuran. 0.29 g (0.00187 mol) of azobis-isobutyronitrile (AIBN) was added thereto (monomer/AIBN=50/1), and stirred in an argon atmosphere at 75 to 80° C. After the reaction was conducted for 6 hours, the solution was left to cool to room temperature. A polymer was precipitated in hexane, filtered, and dried under a reduced pressure to obtain 18 g of poly(2,2,6,6-tetramethylpiperidine methacrylate) (yield: 90%). Next, 10 g of thus obtained poly(2,2,6,6-tetramethylpiperidine methacrylate) was dissolved in 100 ml of dried dichloromethane. To this solution, 100 ml of dichloromethane solution of 15.2 g (0.088 mol) of m-chlorobenzylhydroperoxide was added dropwise at room temperature with stirring over a period of one hour. Furthermore, the solution was stirred for 6 hours, precipitated m-chlorobenzylhydroperoxide was filtered off. A filtrate was washed with an aqueous solution of sodium carbonate and with water, and then dichloromethane was evaporated. A remained solid matter was pulverized, obtained powder was washed with diethyl carbonate (DEC) and dried under a reduced pressure to obtain 7.2 g of poly(4-methacryloyloxy-2,2,6,6-tetramethylpiperidin-1-oxyl) (PTME), which is represented by the formula A-1, and a polymer having a cyclic nitroxyl structure (yield 68.2%, a brown powder). The structure of the obtained polymer was confirmed with IR. In addition, measurements with GPC gave values of weight average molecular weight Mw=89000, and distribution Mw/Mn=3.30. Spin concentration obtained from ESR spectrum was 2.48×10²¹ spin/g.

A radical compound comprising the polymer having a cyclic nitroxyl structure, polyvinylidene fluoride (manufactured by KUREHA CORPORATION) as a binder, and a vapor-grown carbon fiber (an average value of interlayer distances d₀₀₂ of a graphite structure was 0.336 nm and a modulus of elongation was 700 GPa) obtained by pyrolytically decomposing benzene gas and growing a carbon fiber on a substrate to which iron particles were sprayed and baking the carbon fiber at 2800° C. were measured to have weight ratios of 4:1:5, and mixed in n-methylpyrrolidone as a solvent to prepare a slurry. An ultrasonic wave at 40 KHz was irradiated to the slurry for 30 minutes. Then the slurry was coated with a doctor blade onto a 20 μm thick aluminum foil which is a positive electrode collector, dried at 125° C., and n-methylpyrrolidone was evaporated to provide a positive electrode. Thus obtained positive electrode had an active material layer with a thickness of 150 μm. There were no cracks or dropping off from the collector in the dried active material layer. It should be noted that the vapor-grown carbon fiber had a volume resistivity of 300 μΩ·cm, an average length of 10 μm and an average diameter of 0.5 μm.

Then a negative electrode was prepared. Artificial graphite (manufactured by Osaka Gas Co., Ltd.: MCMB25-28) and a rubber binder (manufactured by Japan ZEON Corporation: BM-400B) were dispersed in water at weight ratios of 95:5 to prepare a slurry. The slurry was coated with a doctor blade onto a 10 μm thick copper foil, dried at 80° C., and pressed with a roller to prepare a negative electrode. Thus obtained negative electrode had an active material layer with a thickness of 20 μm. There were no cracks or dropping off from the collector in the dried active material layer.

As for an electrolyte, an electrolyte containing 0.9 mol/l of LiPF₆ as an electrolytic salt was used. The electrolytic salt was dissolved in an electrolytic solvent composed of a mixed solution of ethylene carbonate/diethyl carbonate (mixture ratio by volume 3:7) to prepare the electrolyte.

Thus prepared positive electrode and negative electrode were cut as 12 mm φ discs. The discs were stacked via 25 μm thick porous polypropylene used as a separator and incorporated into an exterior can made of stainless, and sealed after an electrolyte was injected to prepare a coin type secondary battery having a configuration shown in FIG. 1.

### Example 2

The same radical compound as Example 1, the same polyvinylidene fluoride as Example 1, the same vapor-grown carbon fiber as Example 1 and acetylene black (manufactured by DENKI KAGAKU KOGYO KABUSHIKI KAISHA, DENKABLACK) were measured to have weight ratios of 4:1:3:2, and mixed in n-methylpyrrolidone as a solvent to prepare a slurry. An ultrasonic wave at 40 KHz was irradiated to the slurry for 30 minutes. Then the slurry was coated with a doctor blade onto a 20 μm thick aluminum foil which is a positive electrode collector, dried at 125° C., and n-methylpyrrolidone was evaporated to provide a positive electrode. Thus obtained positive electrode had an active material layer with a thickness of 150 μm. There were no cracks or dropping off from the collector in the dried active material layer. A negative electrode, an electrolyte and a separator were prepared as with Example 1 except for the positive electrode to prepare a coin type secondary battery of Example 2.

### Example 3

The same radical compound as Example 1, the same polyvinylidene fluoride as Example 1, a vapor-grown carbon fiber (an average value of interlayer distances d₀₀₂ of a graphite structure was 0.335 nm and a modulus of elongation was 800 GPa) obtained by pyrolytically decomposing benzene gas, growing a carbon fiber on a substrate to which iron particles were sprayed, and baking the carbon fiber at 3000° C., the same acetylene black as Example 2 were measured to have weight ratios of 4:1:1:4, and mixed in n-methylpyrrolidone as a solvent to prepare a slurry. An ultrasonic wave at 40 KHz was irradiated to the slurry for 30 minutes. Then the slurry was coated with a doctor blade onto a 20 μm thick aluminum foil which is a positive electrode collector, dried at 125° C., and n-methylpyrrolidone was evaporated to provide a positive electrode. Thus obtained positive electrode had an active material layer with a thickness of 150 μm. There were no cracks or dropping off from the collector in the dried active material layer. It should be noted that the vapor-grown carbon fiber had a volume resistivity of 200 μΩ·cm, an average length of 10 μm and an average diameter of 0.5 μm. A negative electrode, an electrolyte and a separator were prepared as with Example 1 except for the positive electrode to prepare a coin type secondary battery of Example 3.

### Example 4

As a radical compound, poly(4-acryloyloxy-2,2,6,6-tetramethyl piperidin-1-oxyl) (PTAA) was synthesized, which is represented by chemical formula A-2 (each of R₁ to R₄ represents a methyl group), and a polymer having a cyclic nitroxyl structure.

Synthetic Example of Polymer Having Cyclic Nitroxyl Structure; 10 g of 4-acryloyloxy-2,2,6,6-tetramethylpiperidin-1-oxyl monomer was charged in a 100 ml egg-plant type flask equipped with a reflux condenser, and polymerized at 20° C. for 48 hours in dried tetrahydrofuran with s-butyllithium as a catalyst to obtain 5.8 g of poly (4-acryloyloxy-2,2,6,6-tetramethyl piperidine-1-oxyl) (yield 58%, an orange powder). The structure of the obtained polymer was confirmed with IR. In addition, measurements with GPC gave a value of weight average molecular weight Mw=4300. Spin concentration obtained from ESR spectrum was 2.66×10²¹ spin/g.

A radical compound comprising thus obtained polymer having a cyclic nitroxyl structure, the same polyvinylidene fluoride as Example 1, and a vapor-grown carbon fiber (an average value of interlayer distances d₀₀₂ of a graphite structure was 0.337 nm and a modulus of elongation was 500 GPa) obtained by pyrolytically decomposing benzene gas, growing a carbon fiber on a substrate to which iron particles were sprayed, and baking the carbon fiber at 2500° C., were measured to have weight ratios of 4:1:5, and mixed in n-methylpyrrolidone as a solvent to prepare a slurry. An ultrasonic wave at 40 KHz was irradiated to the slurry for 30 minutes. Then the slurry was coated with a doctor blade onto a 20 μm thick aluminum foil which is a positive electrode collector, dried at 125° C., and n-methylpyrrolidone was evaporated to provide a positive electrode. Thus obtained positive electrode had an active material layer with a thickness of 150 μm. There were no cracks or dropping off from the collector in the dried active material layer. It should be noted that the vapor-grown carbon fiber had a volume resistivity of 800 μΩ·cm, an average length of 20 μm and an average diameter of 0.5 μm. A negative electrode, an electrolyte and a separator were prepared as with Example 1 except for the positive electrode to prepare a coin type secondary battery of Example 4.

### Example 5

As a radical compound, poly (4-vinyloxy-2,2,6,6-tetramethyl piperidin-1-oxyl) (PTVE) was synthesized, which is represented by chemical formula A-3 (each of R₁ to R₄ represents a methyl group), and a polymer having a cyclic nitroxyl structure.

Synthetic Example of Polymer Having Cyclic Nitroxyl Structure; Under an argon atmosphere, to a 200 mL three-necked round-bottom flask, 10.0 g of 2,2,6,6-tetramethyl piperidine-4-vinyl-1-oxyl (monomer) and 100 mL of dichloromethane were charged and cooled to −78° C. Furthermore, 280 mg (2 mmol) of boron trifluoride-diethyl ether complex was added thereto. This solution was made uniform and then a reaction was conducted for 20 hours. After the reaction was complete, a obtained solid matter was washed with methanol several times and subjected to vacuum drying to obtain poly(4-vinyloxy-2,2,6,6-tetramethylpiperidin-1-oxyl) (PTVE) as a red solid (yield 70%). The structure of the obtained polymer was confirmed with IR spectrum. In addition, measurements of a DMF soluble portion with GPC gave values of weight average molecular weight Mw=89000, and distribution Mw/Mn=2.7. Spin density obtained from ESR spectrum was 3.05×10²¹ spin/g.

A radical compound comprising thus obtained polymer having a cyclic nitroxyl structure, the same polyvinylidene fluoride as Example 1, and a vapor-grown carbon fiber (an average value of interlayer distances d₀₀₂ of a graphite structure was 0.340 nm and a modulus of elongation was 200 GPa) obtained by pyrolytically decomposing benzene gas, growing a carbon fiber on a substrate to which iron particles were sprayed, and baking the carbon fiber at 2300° C., were measured to have weight ratios of 4:1:5, and mixed in n-methylpyrrolidone as a solvent to prepare a slurry. An ultrasonic wave at 40 KHz was irradiated to the slurry for 30 minutes. Then the slurry was coated with a doctor blade onto a 20 μm thick aluminum foil which is a positive electrode collector, dried at 125° C., and n-methylpyrrolidone was evaporated to provide a positive electrode. Thus obtained positive electrode had an active material layer with a thickness of 150 μm. There were no cracks or dropping off from the collector in the dried active material layer. It should be noted that the vapor-grown carbon fiber had a volume resistivity of 2000 μΩ·cm, an average length of 20 μm and an average diameter of 0.5 μm. A negative electrode, an electrolyte and a separator were prepared as with Example 1 except for the positive electrode to prepare a coin type secondary battery of Example 5.

### Example 6

PTVE synthesized as with Example 5, the same polyvinylidene fluoride as Example 1, and a graphitized carbon fiber derived from a mesophase pitch as a precursor (manufactured by PETOCA LTD, an average value of interlayer distances d₀₀₂ of a graphite structure was 0.337 nm, a modulus of elongation was 550 GPa, a volume resistivity of 400 μΩ·cm, an average length of 70 μm and an average diameter of 0.6 μm) were measured to have weight ratios of 4:1:5, and mixed in n-methylpyrrolidone as a solvent to prepare a slurry. An ultrasonic wave at 40 KHz was irradiated to the slurry for 30 minutes. Then the slurry was coated with a doctor blade onto a 20 μm thick aluminum foil which is a positive electrode collector, dried at 125° C., and n-methylpyrrolidone was evaporated to provide a positive electrode. Thus obtained positive electrode had an active material layer with a thickness of 135 μm. There were no cracks or dropping off from the collector in the dried active material layer. A negative electrode, an electrolyte and a separator were prepared as with Example 1 except for the positive electrode to prepare a coin type secondary battery of Example 6.

### Comparative Example 1

The same radical compound as Example 1, the same polyvinylidene fluoride as Example 1, and the same acetylene black as Example 2 were measured to have weight ratios of 4:1:5, and mixed in n-methylpyrrolidone as a solvent to prepare a slurry. An ultrasonic wave at 40 KHz was irradiated to the slurry for 30 minutes. Then the slurry was coated with a doctor blade onto a 20 μm thick aluminum foil which is a positive electrode collector, dried at 125° C., and n-methylpyrrolidone was evaporated to provide a positive electrode. Thus obtained positive electrode had an active material layer with a thickness of 150 μm. There were cracks and dropping off from the collector in the dried active material layer. A negative electrode, an electrolyte and a separator were prepared as with Example 1 except for the positive electrode to prepare a coin type secondary battery of Comparative Example 1.

### Comparative Example 2

The same radical compound as Example 1, the same polyvinylidene fluoride as Example 1, and a gold powder (average particle diameter 3 μm) were measured to have weight ratios of 4:1:5, and mixed in n-methylpyrrolidone as a solvent to prepare a slurry. An ultrasonic wave at 40 KHz was irradiated to the slurry for 30 minutes. Then the slurry was coated with a doctor blade onto a 20 μm thick aluminum foil which is a positive electrode collector, dried at 125° C., and n-methylpyrrolidone was evaporated to provide a positive electrode. Thus obtained positive electrode had an active material layer with a thickness of 150 μm. There were cracks and dropping off from the collector in the dried active material layer. A negative electrode, an electrolyte and a separator were prepared as with Example 1 except for the positive electrode to prepare a coin type secondary battery of Comparative Example 2.

### (Evaluation of Battery Characteristics)

The coin type secondary batteries of Examples 1 to 6 and Comparative Examples 1 and 2 were subjected to charge and discharge in the voltage range of 2 V to 4 V at a constant current. The charge and discharge was conducted in a thermostatic chamber set at 20° C. The charge current was a 1C current and the discharge current was a 1C current and a 50C current, and a discharge capacity was measured in each case. It should be noted that the 1C current is a current value that discharge is complete in an hour, and the 50C current is a current 50 times higher than the 1C current. As an amount showing capacity characteristics on discharge of a large current of the secondary battery, a ratio of a discharge capacity at the 50C current to a discharge capacity at the 1C current was measured.

In addition, the prepared coin type secondary battery was charged with the 1C current to 4 V, stored in a thermostatic chamber set at 20° C. for a week, then discharged with the 1C current to 2 V, and its remained capacity was measured. As an amount showing storage characteristics of a capacity of the secondary battery, a ratio of a remained capacity after a lapse of a week to a discharge capacity before the storage was measured.

As for the secondary batteries of Examples 1 to 6 and Comparative Examples 1 and 2, the state of appearances and measurement results of the characteristics of each positive electrode are shown in Table 1.

TABLE 1

| | | | | | | Discharge |
|---|---|---|---|---|---|---|
| | | | | | 50 C | Capacity after a |
| | Mixture | Modulus of | Volume | Presence or | Discharge | Week/ |
| | Ratio of | Elongation | Resistivity | Absence of | Capacity/1 C | Discharge |
| | Carbon | of Carbon | of Carbon | Cracks or | Discharge | Capacity before |
| | Fiber | Fiber | Fiber | Dropping off | Capacity | Storage |
| | (%) | (GPa) | (μΩ · cm) | of Electrode | (%) | (%) |
| Example 1 | 50 | 700 | 200 | None | 62 | 92 |
| Example 2 | 30 | 700 | 200 | None | 55 | 92 |
| Example 3 | 10 | 800 | 200 | None | 51 | 91 |
| Example 4 | 50 | 500 | 800 | None | 60 | 93 |
| Example 5 | 50 | 200 | 2000 | None | 58 | 92 |
| Example 6 | 50 | 550 | 400 | None | 60 | 91 |
| Comparative | — | — | — | Present | 30 | 30 |
| Example 1 | | | | | | |
| Comparative | — | — | — | Present | — | — |
| Example 2 | | | | | | |

The positive electrodes of Examples 1 to 6 did not have cracks or dropping off, whereas cracks or dropping off were caused in the positive electrodes of Comparative Examples 1 and 2. The reason why the positive electrodes of Examples 1 to 6 did not have cracks or dropping off is that each active material layer comprised a carbon fiber in which a graphite structure has an average value of interlayer distances d₀₀₂ in the range of not less than 0.335 nm and not more than 0.340 nm, thereby increasing the mechanical strength of the active material layer of the positive electrode.

As for the ratio of a discharge capacity at the 50C current to a discharge capacity at the 1C current, all the ratios of the secondary batteries of Examples 1 to 6 were larger than the ratio of the secondary battery of Comparative Example 1. This indicates that, in the secondary batteries of Examples 1 to 6, there are no cracks in the active material layers of the positive electrodes and the active material layers have high electrical conductivities and positive electrodes have low electrode resistances, and thus discharge capacities at large currents are higher than the Comparative Example.

As for the ratio of a remained capacity after storage of a week to a discharge capacity before the storage, all the ratios of the secondary batteries of Examples 1 to 6 were larger than the ratio of the secondary battery of Comparative Example 1. This indicates that, in the secondary batteries of Examples 1 to 6, there is no dropping off of the active material layers, and thus storage characteristics of a capacity are higher than the Comparative Example.

In addition, in the secondary battery of Comparative Example 2, no capacity was obtained on the discharge with the 1C current, and it was impossible to obtain the ratio of the 50C to a discharge capacity at the 1C current and the ratio of a discharge capacity after storage of a week to a discharge capacity before the storage. It is considered that charge transfer resistance at an interface between the radical compound and the gold particles is remarkably larger than the case of a carbon fiber and a charge and discharge reaction did not proceed. Therefore, use of an active material layer containing gold instead of a carbon fiber, though gold and a carbon fiber are conductive materials, does not provide a positive electrode having a low electric resistance.

1. A positive electrode for a secondary battery, which comprises an active material layer at least comprising a radical compound and a carbon fiber in which a graphite structure has an average value of interlayer distances d₀₀₂ in the range of not less than 0.335 nm and not more than 0.340 nm.

2. The positive electrode for a secondary battery according to claim 1, wherein the carbon fiber has a modulus of elongation in the range of not less than 200 GPa and not more than 800 GPa.

3. The positive electrode for a secondary battery according to claim 1, wherein the carbon fiber has a volume resistivity in the range of not less than 200 μΩ·cm and not more than 2000 μΩ·cm.

4. The positive electrode for a secondary battery according to claim 1, wherein the carbon fiber is a vapor-grown carbon fiber.

5. The positive electrode for a secondary battery according to claim 1, wherein the carbon fiber is a graphitized carbon fiber derived from a mesophase pitch as a precursor.

6. The positive electrode for a secondary battery according to claim 1, wherein the active material layer contains the carbon fiber in the range of not less than 10 weight % and not more than 50 weight %.

7. The positive electrode for a secondary battery according to claim 1, wherein the radical compound comprises at least one of a polymeric nitroxyl radical compound, a polymeric oxy radical compound, and a polymeric hydrazyl radical compound.

8. The positive electrode for a secondary battery according to claim 7, wherein the polymeric nitroxyl radical compound is poly(4-methacryloyloxy-2,2,6,6-tetramethyl piperidine-1-oxyl), poly(4-acryloyloxy-2,2,6,6-tetramethyl piperidine-1-oxyl), or poly(4-vinyloxy-2,2,6,6-tetramethyl piperidine-1-oxyl).

9. A method for manufacturing a positive electrode for a secondary battery comprising an active material layer at least comprising a radical compound and a carbon fiber, which comprises a step of dispersing the carbon fiber in which a graphite structure has an average value of interlayer distances d₀₀₂ in the range of not less than 0.335 nm and not more than 0.340 nm in a solvent containing the radical compound.

10. The method for manufacturing a positive electrode for a secondary battery according to claim 9, wherein the carbon fiber is dispersed so that the active material layer contains the carbon fiber in the range of not less than 10 weight % and not more than 50 weight %.

11. A secondary battery comprising at least a positive electrode, a negative electrode, and an electrolyte, wherein the positive electrode is the positive electrode for a secondary battery according to claim 1.
